(19) United States
(12) Patent Application Publication
(10) Pub. No.: US 2007/0077326 A1
(43) Pub. Date: Apr. 5, 2007

(54) Childproof Press for Fusing Beads

(76) Inventor: Kristina L Smith, Dana Point, CA (US)

Correspondence Address: QUICKPATENTS, INC., 31877 DEL OBISPO, SUITE 202, SAN JUAN CAPISTRANO, CA, 92675, US

(21) Appl. No.: 11/535,948

(22) Filed: Sep. 27, 2006

Related U.S. Application Data
(60) Provisional application No. 60/721,973, filed on Sep. 30, 2005.

(51) Int. Cl. B29C 43/58; B29C 43/04; B29C 43/52

(52) U.S. Cl. 425/407; 425/135; 425/415

(57) ABSTRACT

The press for fusing beads heats the tops of beads to fuse the beads together, fixing them in a pattern. The press includes an enclosure having a slot defined in the front face. A heating plate having a heating element is mounted within the enclosure. A tray, which holds the beads to be fused, is placed on a tray support that slides within the open slot to a position under the heating plate. A control circuit senses the position of the tray support, and when the tray is in position beneath the heating plate, allows an operator to initiate a timed heating cycle and locks the tray in place. When the heating cycle is initiated, the heating plate is brought into close proximity with the tray, placing the tops of the beads into contact with the heating plate and energizing the heating element to heat the heating plate to a predetermined temperature.

### CROSS-REFERENCE TO RELATED APPLICATIONS

This application claims the benefit of U.S. Provisional Patent Application 60/721,973 filed on Sep. 30, 2005.

### STATEMENT REGARDING FEDERALLY SPONSORED RESEARCH AND DEVELOPMENT

Not Applicable.

### FIELD OF THE INVENTION

The present invention relates to a heating appliance, and in particular, to a heated press for fusing plastic materials such as plastic beads.

### DISCUSSION OF RELATED ART

Many children enjoy crafts and hobbies that allow them to form artistic or useful shapes from plastic. These types of hobbies are beneficial to young children as the hobbies are opportunities for the child to practice attention to detail, to develop manual dexterity, and to express creativity.

One such hobby is the making of artistic shapes by fusing plastic beads. Bead fusing uses small cylindrically shaped beads. The beads are available in a wide range of colors and sizes. To produce a shape or object, the beads are placed in a mold with pegs for holding the beads. The cylindrically shaped beads are slid over the pegs in the mold. The hobbyist selects the colors of beads appropriate for his or her design and chooses the peg for each bead in order to create the desired design. To finish the project, the bead tops are fused. Fusing uses a heat source to melt the tops of the beads together to fuse the beads into the desired pattern. Conventionally, a clothing iron is used as the heat source for melting the beads. The tops of the beads are covered with a thin, non-stick material so that the melted beads do not adhere to the surface of the iron. A typical material used to protect the iron is a wax-coated paper.

After the tops of the beads are fused and the beads have cooled, the project can be removed from the mold. Many hobbyists repeat the fusing process on the back of their projects to make the finished product sturdier.

A first concern associated with the practice of bead fusing by small children is the risk of burn injuries. A type of bead typically fused has a melting temperature of approximately 200° F.-220° F. Children four years of age and older enjoy bead fusing. Younger children in particular may not appreciate the hazard associated with the high temperatures, placing them at risk of receiving burns when handling the hot iron or when handling heated beads. As a result, adults must closely supervise children when they are fusing beads. For very young children, adults must perform the fusing operation for the child. When an adult performs the fusing for the child, the child misses out on some of the enjoyment and benefits of participating in the hobby. It would be beneficial if young children could safely apply the fusing heat source themselves without exposure to a risk of receiving a burn injury.

A second concern is controlling the relevant process variables to achieve a reliable fusing of the bead tops. When the beads are excessively melted, the appearance of the bead project is degraded, while incompletely fused bead projects are similarly unattractive and less sturdy than a properly fused project. The important variables to control during fusing are the temperature of the iron and the duration of the application of iron's heat to the beads. Unfortunately, the temperature controls on irons are only roughly calibrated. Generally, irons do not indicate a temperature setting in degrees, but rather display temperature adjustment ranges labeled like “cotton” or “permanent press,” indicating the types of fabric to be ironed at that setting. Because the fabric settings are not standardized, there can be wide variation in temperature of an iron adjusted to the “cotton” setting. It would be advantageous if the temperature of the heat source were reliably adjusted to a known value so that ideal fusing of beads may be reliably accomplished.

Several devices have been developed for heating and shaping plastic materials. German Patent No. 3,919,164, published Dec. 13, 1990, describes a device with a movable upper plate that presses against the contour of plastic materials to weld or cut the materials. German Patent No. 3,938,380, published May 23, 1991, describes an apparatus with a movable press plate and a non-stick slip film for extruding plastic material. German Patent No. 19,858,152, published Jun. 21, 2000, describes an apparatus for the production of plastic boards, including a press with heated and cooled sections for stretching plastic materials. Japanese Patent No. 57-155,255, published Sep. 25, 1982, describes a press-molding apparatus for producing a molded article from thermosetting resin containing glass beads.

None of the above inventions and patents describes the present invention as claimed. Thus, a press for fusing beads solving the aforementioned problems is desired.

### SUMMARY OF THE INVENTION

The press for fusing beads heats the tops of beads to fuse the beads together, fixing them in a pattern. The press preferably includes a control circuit that ensures a consistent, repeatable heating cycle used in the fusing process, and that operates the press to achieve an enhanced degree of safety for a user. The press includes an enclosure having an open slot at the front face. A heating plate having a heating element is mounted within the enclosure. A tray, which holds the beads to be fused, is placed on a tray support that slides within the open slot to a position under the heating plate. A control circuit senses the position of the tray support, and when the tray is in position beneath the heating plate, allows an operator to initiate a timed heating cycle. When the heating cycle is initiated, the control circuit either activates an actuator within the enclosure to move the tray upward, placing the tops of the beads into contact with the heating plate, and energizes the heating element to heat the heating plate to a predetermined temperature; or the user uses a manual vertical actuator mechanism to lower the heating element onto the beads in the tray manually.

At the completion of the heating cycle, the heating element is de-energized, and the control circuit either controls the positioning actuator to lower the tray back upon the tray support, or indicates to the user that the melting cycle is complete and that the user should raise the heating element back into its elevated position.

The press may provide a number of additional actuators and sensors to detect conditions associated with the press and to control the operation of the press. The press may include a fan in electrical connection with the control circuit. The control circuit operates the fan to cool beads and the internal components of the press at the end of a heating cycle. An electrically operated latch for holding the tray support plate within the press may be provided, or a locking post on the lowerable heating assembly may mechanically engage a locking post receiving means of the tray to prevent the tray from being slid out of the slot of the enclosure. The latch is electrically connected to the control circuit, which operates the latch to prevent the tray from being removed from the press during and after the heating cycle, while the beads are still hot. The press may be provided with indicator lights and a display that provide information to the user concerning the state of operation of the press, allowing the user to understand when it is safe to start the press and when to remove the bead tray from the press. The display can further provide an indication of abnormal or potentially unsafe conditions monitored by sensors within the enclosure.

These and other features of the present invention will become readily apparent upon further review of the following specification and drawings.

### DESCRIPTION OF THE DRAWINGS

FIG. 1A is a perspective view of a press for fusing beads according to the present invention as seen from the front.

FIG. 1B is a perspective view of the press of FIG. 1A as seen from the rear.

FIG. 1C is a perspective view of the press of FIG. 1A as seen from the bottom.

FIG. 2 is a perspective view of a press for fusing beads according to the present invention, broken away and partially in section to show details of the tray holder assembly.

FIG. 3 is a perspective view of a press for fusing beads according to the present invention, broken away and partially in section to show details of the heating element assembly.

FIG. 4 is a block diagram of a computer-based safety control circuit for the press of the present invention.

FIG. 5 is a process diagram showing operations implemented by the safety control circuit of FIG. 4.

FIG. 6 is a top plan view of the preferred embodiment of the invention, illustrating a tray support plate in an extend position.

FIG. 7A is a left-side elevational view of the preferred embodiment of the invention, partially broken away, illustrating the tray support plate in the extended position.

FIG. 7B is a left-side elevational view of the preferred embodiment of the invention, partially broken away, illustrating the tray support plate, and a tray thereon, under a heating plate of the present invention.

FIG. 7C is a left-side elevational view of the preferred embodiment of the invention, partially broken away, illustrating the heating plate in a lowered position and in contact with beads on the tray.

FIG. 7D is a left-side elevational view of the preferred embodiment of the invention, partially broken away, illustrating a scraper being introduced into a second slot of invention, the scraper dislodging fused beads from the heating plate.

FIG. 8 is a perspective illustration of the preferred embodiment of the invention. Similar reference characters denote corresponding features consistently throughout the attached drawings.

### DETAILED DESCRIPTION OF THE PREFERRED EMBODIMENT

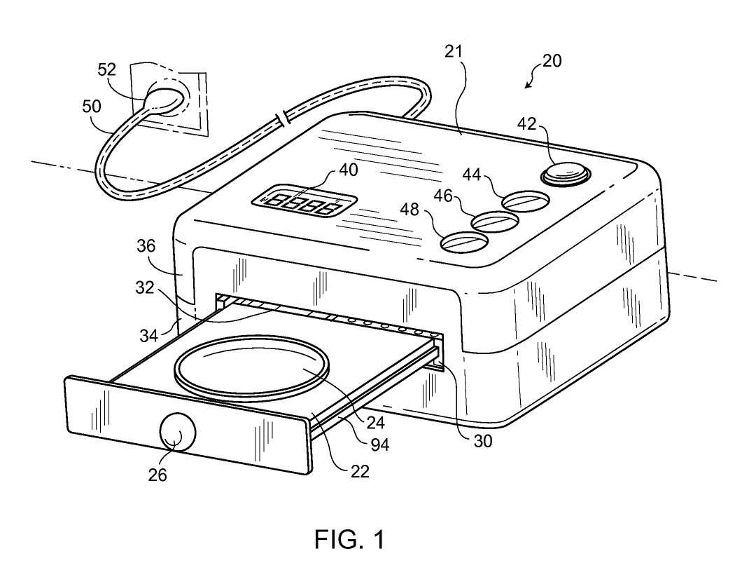

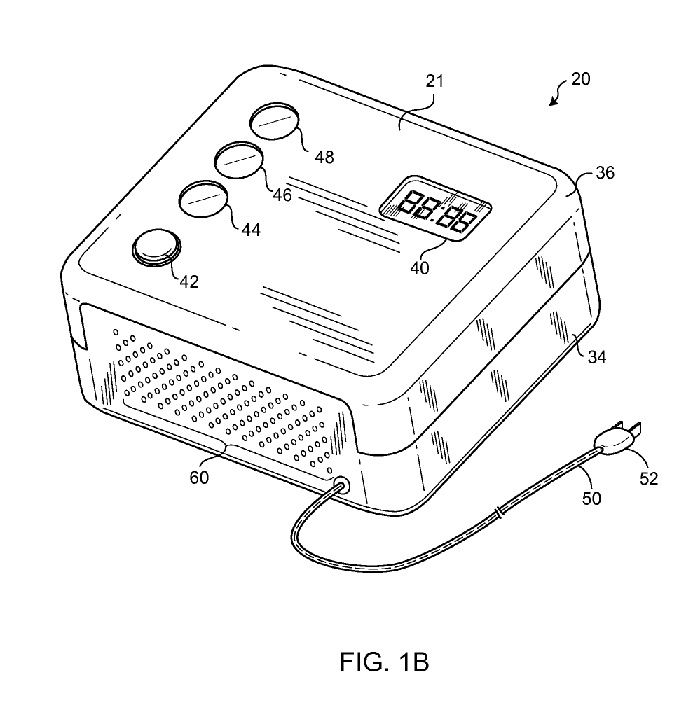

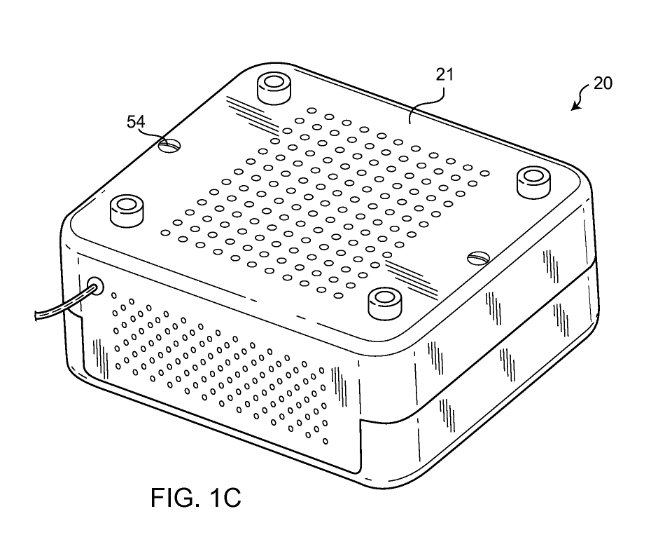

The present invention is a press for fusing beads, designated generally as 20 in the drawings. As shown in FIGS. 1A, 1B, and 1C, the press is shown to include an enclosure 21 with user interface components 230 on the exterior of the enclosure 21. The user interface components 230 may include an alphanumeric display 40, indicator lights 44, 46, 48, and a start button 42. A control circuit 200, described below, controls the operation of the press 20, sensing the pressing of the start button 42 to start a bead fusing cycle and indicating, via the indicating lights 44, 46, and 48 and the alphanumeric display 40, the operating state of the press 20. The control circuit 200 also monitors sensors 224 within the press 20 to detect conditions that might potentially result in unsafe operation.

Electrical power for controlling and operating the press 20 is provided via an electrical power cord 50 terminating in an electrical plug 52. The plug 52 is adapted for connection to a source of electrical power from a conventional AC receptacle, such as 110V AC in North America and 220V AC in Europe, for example.

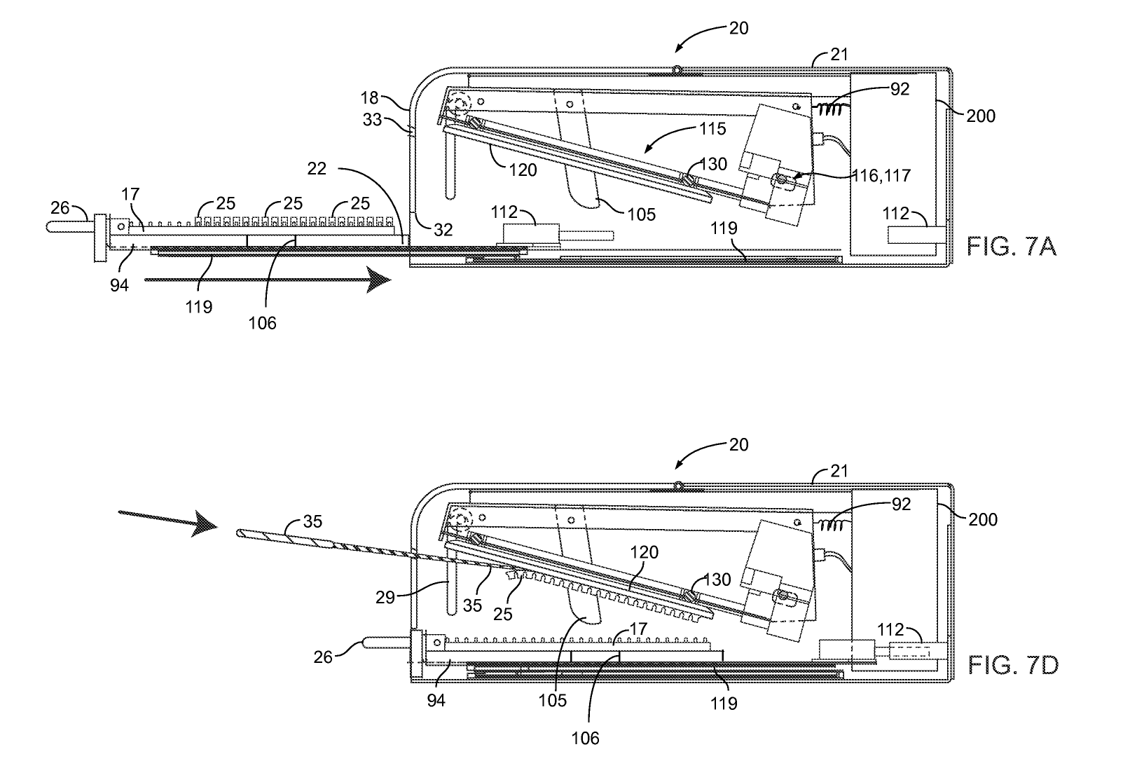

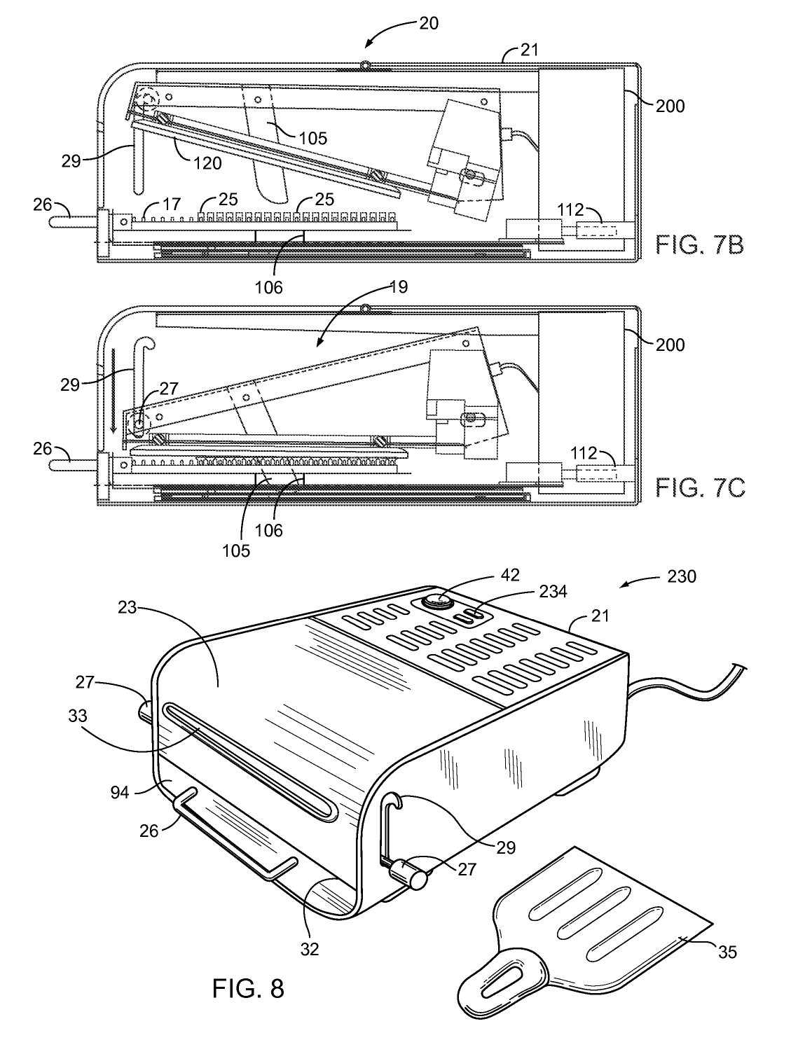

The press 20 further comprises a tray support plate 94. The tray support plate 94 slidably engages a tray guide 30 so that the tray support plate 94 can be slid within the enclosure 21 of the press 20. The drawer guide 119 (FIG. 7A) may be further included to support the tray support plate 94 between its extended and retracted positions. A handle or knob 26 attached to the front of the tray support plate 94 provides a purchase that allows a user to slide the tray support plate 94 in or out of the press 20. The upper surface of the tray support plate 94 is adapted to hold a tray 22. A recessed area 24 of the tray 22 is adapted to hold a bead mold 17 containing beads 25 to be fused by the press 20.

The enclosure 21 is comprised of an upper portion 36 and a lower portion 34 that are assembled to form the enclosure 21 with a front opening 32 for inserting the tray 22. The assembled enclosure 21 defines a substantially hollow interior 19 within the upper portion 36 and the lower portion 34. The enclosure 21 may be made of any suitably strong, temperature-resistant material, such as metal or heat-resistant plastic.

Referring now to FIG. 1B, details of the rear of the press 20 may be appreciated. The rear of the enclosure 21 is provided with ventilation openings 60. An internal fan 80 exhausts warm air from within the enclosure 21 during a cooling cycle described below. The power supply cord 50 is preferably retractable within the enclosure 21 of the press 20.

Referring to FIG. 1C, one of the safety features of the press 20 may be appreciated. A child resistant latching mechanism 54 is provided. The child resistant latch 54 comprises one or more screw fasteners. The heads of the fasteners are preferably recessed below the surface of the enclosure 21 when fully latched, making the screws difficult for young children to operate without the assistance of a tool. Because the latch mechanism 54 is located on the bottom of the enclosure and requires a tool to operate, the latch mechanism 54 is not readily operable by underage children. By limiting the ability of children to open the enclosure 21, the risk of a burn or an electrical shock to a child by accessing energized elements within the press 20 is reduced. Other appropriate child proof latching mechanisms that may be known in the art may also be used.

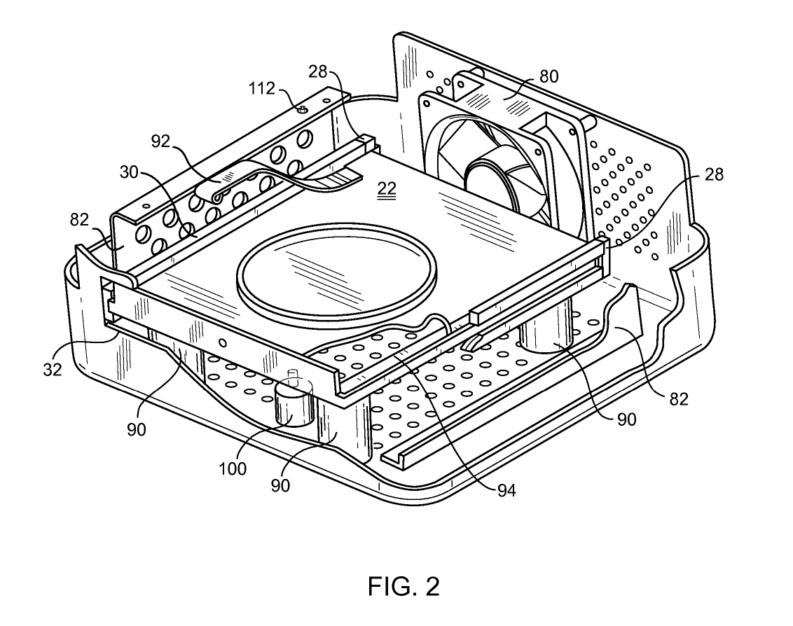

By referring now to FIG. 2, internal details of the press 20 may be understood. The tray support plate 94 described above is shown fully inserted within the lower housing 34 of the enclosure 21. A pair of tray guides 30 are supported by side frames 82 disposed within the lower housing 34. Each tray guide 30 defines an elongated guide slot. The tray support plate 94 slidably engages the tray guide slots, allowing the tray support plate 94 carrying a tray 22 to slide into or out of the press 20. Preferably, a drawer guide 119 may also be used to support the tray support plate 94 (FIG. 7A).

When the tray support plate 94 is fully inserted within the enclosure 21 of the press 20, leaf springs 92 mounted to a fixed support within the hollow interior 119 are biased to hold the tray 22 in a lowered position on the tray support plate 94. In the lowered position, the tops of fuser beads 25 disposed in a mold 17 placed in the bead mold holder 24 of the tray 22 are held away from contact with a heating plate 120, described below.

A linear actuator mechanism 90 may be provided in one embodiment to lift the tray 22 to a raised position above the tray support plate 94. In the raised position, the tops of fuser 25 beads disposed in a mold 17 supported by the tray 22 are placed in contact with the heating plate 120, described below. The linear actuator mechanism 90 may be comprised of a plurality of solenoids 90 disposed within the lower housing 34. When energized, the solenoids 90 lift the tray the tray 22 away from the tray support plate 94 against the force of the tray springs 92 to the raised position. When the solenoids 90 are de-energized, the springs 92 return the tray 22 to the lowered position.

An electrically operated latching mechanism 100 may be provided in one embodiment for holding the tray 22 in position. The latching mechanism 100 can be electrically energized to hold the tray support plate 94 in position within the press 20 during a heating operation and released to allow the tray support plate 94 to be withdrawn from or inserted into the press 20. In the illustrated embodiment, the latching mechanism 100 comprises a solenoid-operated latch 100. When the solenoid 100 is energized, the plunger of the latching solenoid 100 rises to engage an opening in the tray support plate 94, holding the tray 22 in place while the solenoid 100 is energized. De-energizing the latching solenoid 100 lowers the plunger, unlatching the tray support plate 94. Alternatively, a solenoid 100 with the opposite operating sense may be employed, so that the tray support plate 94 is latched by de-energizing the solenoid 100 and unlatched by energizing the solenoid 100.

The ventilation fan 80 disposed within the housing of the press 20 draws ambient air within the enclosure 21 through ventilation openings 60 in order to cool the fused beads 25 after a heating cycle. The fan 80 exhausts the heated air outside of the enclosure 21. Preferably the fan 80 is positioned and operated to exhaust the air away from the front opening 32 at the front of the press 20 so that the heated air is not directed towards a user operating the press 20.

Sensors 224 disposed within the housing are provided to detect conditions that indicate a safe or unsafe condition for operating the press 20. One or more position detecting sensors 28 are located at the ends of a tray guide slot to detect whether or not the tray support plate 94 is fully inserted within the press 20. The sensors may include photoelectric sensors comprising a light emitter element and a photo detector element separated by a gap positioned at the end of the tray guide slot. When the tray support plate 94 is not fully inserted, the light from the light emitter is detected by the photo detector element. When the tray support plate 94 is fully inserted, the plate 94 shadows the photo detector, interrupting the light from the light emitter element. Monitoring the output response of the photo detector provides an indication of whether the tray support plate 94 is fully inserted.

A proximity detector sensor 112 detects whether the upper enclosure housing 36 is in place, sealing off access to the internal components of the device from users during operation. The proximity sensor may be a microswitch 112 mounted on a portion of the lower housing 34 or a lower housing component, such as the tray guide support frame 82. The proximity switch condition, closed or open, may be monitored to detect the state of assembly of the housing for the press 20.

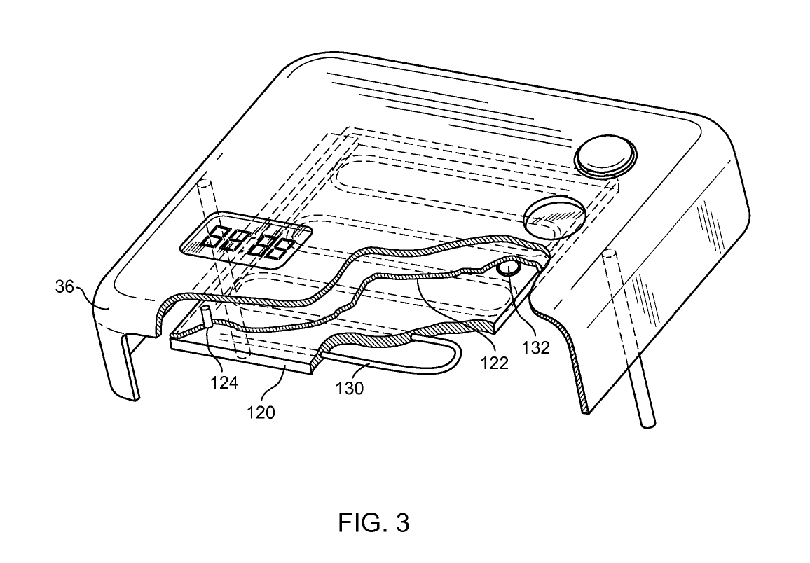

Referring now to FIG. 3, the details of the heating plate assembly 115 in one embodiment may be appreciated. Preferably the components of the heating plate assembly 115 are installed within the upper housing 36, allowing access to the region between the heating plate 120 and the lower assembly when the enclosure 21 is opened. Alternatively, the components of the heating assembly 115 may be mounted from supports fixed in the lower housing 34.

A flat heating plate 120 made of a thermally conductive material, such as stainless steel or other metal, is disposed within the upper housing 36 and supported by a plurality of insulated mounts 124 from the upper housing 36. The insulated mounts 124 may be resilient mounts that yield under a vertical pressing force to allow the press 20 to accommodate beads 25 of varying heights being pressed against the heater by the tray actuators described above. Alternatively, larger beads 25 may be accommodated by providing resilient supports for the tray positioning actuators.

The heating plate 120 is provided with a heating element 130. The heating element 130 may be a resistive heating element 130 that converts electrical energy to heat when a current is passed through the element 130. The heating element 130 may be embedded in the heating plate 120, or alternatively, may be disposed on a surface of the heating plate 120.

The lower surface of the heating plate 120 may be provided with a non-stick coating to prevent melted bead material from sticking to the surface of the heating plate 120. Preferable the non-stick coating is a thin layer of a polymeric material, such as polytetrafluoroethylene (PTFE). Other materials may be used provided that they are stable under the anticipated temperatures for the heating plate 120, have non-stick properties so that they do not adhere to the material of the beads 25, and which do not chemically interact with the bead material.

A temperature sensor 132 may be provided on the heating plate 120 for monitoring the temperature of the heating plate 120. The temperature sensor 132 may be a component whose electrical properties very with temperature, such as a temperature sensitive resistor or thermister. Alternatively, a temperature sensitive switch (not shown) that opens or closes at a fixed or preset temperature set point can provide an indication of whether the heating plate temperature is above or below a given point. Alternatively, the heating element 130 may be comprised of a material whose resistance varies with temperature so that measuring the voltage and current associated with the heating element 130 provides an indication of the heating plate 120 temperature. For example, the heating element 130 may be made of an alloy, such as nichrome, that has a positive temperature coefficient of resistance.

An insulating barrier 122 may be disposed between the inner surface of the upper housing 36 and the heating plate 120. The insulating barrier 122 is preferably composed of a thermally insulating material able to withstand the anticipated temperatures attained by the heating element 130. Such materials as thermosetting plastics, mica or other suitable materials may be used. The insulating barrier 122 serves to keep the external surfaces of the enclosure 21 cool to the touch to prevent the development of hot spots on the enclosure 21 that may present a burn hazard to users.

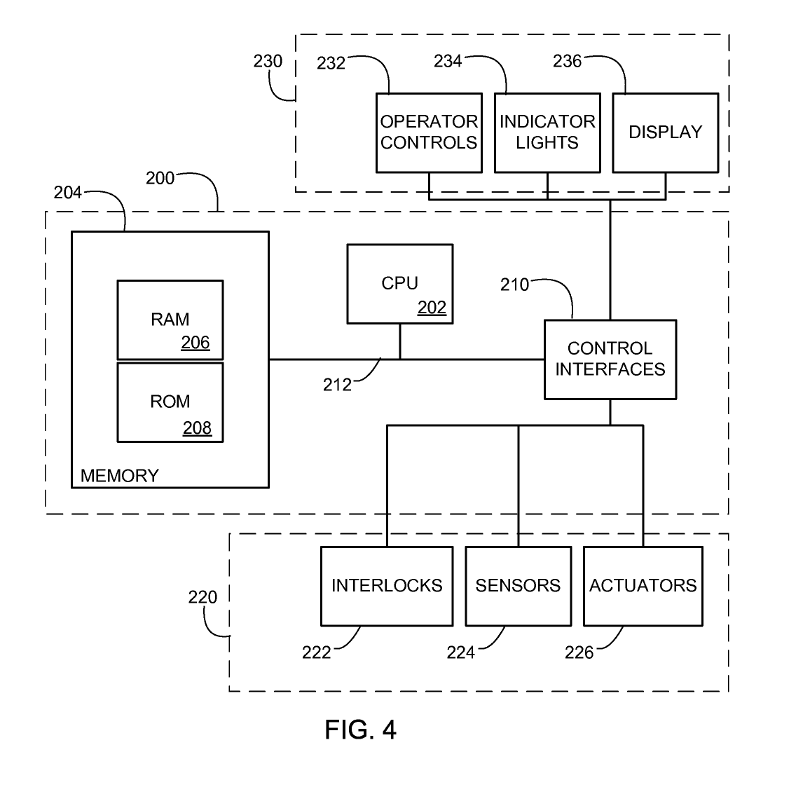

By referring to FIGS. 1A and 4, details of the safety control circuit 200 for the press 20 may be understood. The safety control circuit 200 comprises a memory 204, a central processing unit (CPU) 202 and control interfaces 210. A control bus 212 couples the memory 204 and control interfaces to the CPU 202. The memory 204 may be comprised of random access memory (RAM) 206 and read only memory (ROM) 208. The random access memory 206 may store instructions from an executing program and data, such as information read by the CPU 202 or generated as the result of calculations performed by the CPU 202. The ROM 208 is a non-volatile storage area that stores fixed data and operating instructions to be executed by the CPU 202. The CPU 202 reads program instructions stored by the memory 204 and executes the instructions to provide the functionality required by the control circuit 200. The control interfaces 210 facilitate communications between the CPU 202 and components external to the control circuit 200. The external components include the user interface components 230 and the device control components 220. The user interface components 230 comprise the operator controls 232 that include the start button 42 used to initiate the electrically controlled operations of the press 20. The indicator lights 234 are controlled by the central processing unit 202 to indicate the current state of the press 20. The indicator lights may include a illuminator for the start button 42 to indicate that a heating cycle may be safely started, a red light 44 indicating that a heating cycle is in progress, a yellow light 46 indicating that the press 20 is executing a cooling cycle, and a green ready light 48 to indicate that the cooling is complete and that beads may be safely removed from the machine. The user interface 230 may also include an alphanumeric display 236 providing a descriptive indication of the operating state of the press 20. The display 40 may provide an indication of the time remaining in a cooling cycle.

The operating condition of the machine is sensed and controlled by the CPU 202 via the device control components 220. The device control components 220 include the interlocks 222 that inhibit unsafe operation of the machine, sensors 224 that detect conditions within the press 20, and the actuators 226 via which conditions of the press 20 are set by the CPU 202. Referring to FIGS. 2 and 3, the interlocks 222 comprise the tray latch 100 that is operated to prevent the tray 22 from being removed from the press 20 during a heating cycle or prior to cooling down after a heating cycle. The actuators include the heating element 130, which is energized to control the temperature of the heating plate 120 during a heating cycle, and the tray actuators, which are controlled to move the tray 22 towards or away from the heating plate 120 to position the beads into contact with the heating plate 120 for fusing and away from the heating plate 120 during a cooling cycle. The actuators further include the fan 80 used to provide cooling during a cooling cycle.

The sensors 224 include the tray position sensors 28, the heater temperature sensor 132, and the enclosure proximity sensor 112 described above.

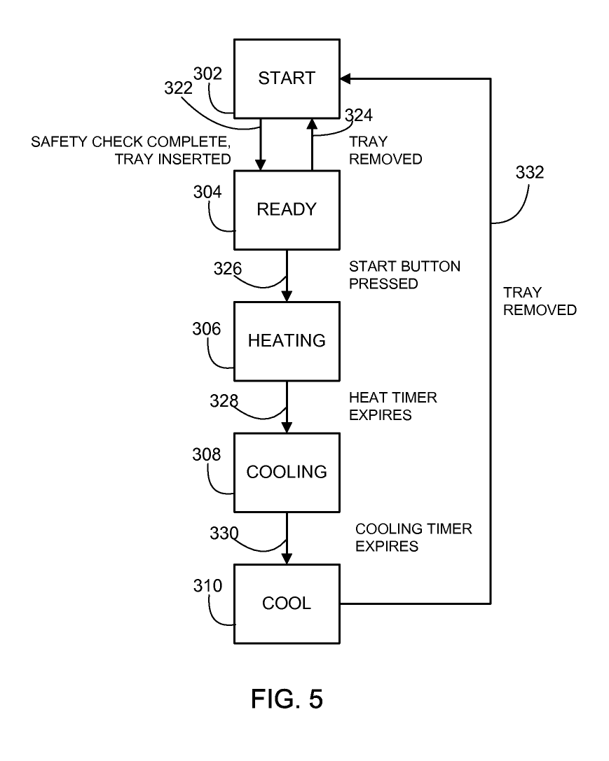

By referring to the process diagram shown in FIG. 5, and FIGS. 1A, 2, 3, and 4, the control logic implemented by the safety control circuit 200 may be understood. As shown in FIG. 5, operation of the control logic begins in the start state 302. To begin operation from the start state fuser beads are placed in the bead pegboard, which is then placed in the holder 24 in the tray 22. The tray 22 is placed on the tray support plate 94. The tray support plate 94 is then pushed into the front slot 32 of the press 20. While in the start state 302, the control circuit 200 monitors the condition of the sensors 224 to detect if the device is prepared to enter the ready state 304. The monitoring includes checks to ensure that the enclosure 21 is closed and that the tray support plate 94 and tray 22 are fully inserted using the sensors described above.

In the start state 302, the indicator lights, including the illumination for the start button 42 and the illuminator light, are extinguished. Pressing the start button 42 while in the start state 302 has no effect on circuit operation. Once the initial safety checks are completed, the control circuit 200 enters the ready state 304 via path 322. In the ready state 304, the start button illumination is energized, indicating that the user may initiate a bead fusing operation by pressing the start button 42. While in the ready state 304, the control logic continues to monitor the sensors 224, and if a not ready condition is sensed, such as the tray 22 being not fully inserted or the enclosure 2] being open, the control logic transitions back to the start state 302 via path 324. A message may be generated and sent to the display 40 to indicate one or more of the conditions that caused the control logic to transition back to the start state 302.

If the start button 42 is pressed while the control logic is in the ready state 304, the control logic transitions to the heating state 306 via path 326. In the heating state 306, a heating cycle is initiated to fuse the tops of beads in the bead tray. The tray latch 100 is engaged to prevent the tray 22 from being retracted during the heating cycle. The tray actuators 90 are energized to raise the tray 22 so that the tops of the beads contact the heating plate 120, and the heating element is energized and controlled to maintain the heating plate 120 at the desired predetermined temperature for fusing the plastic beads. The value for the predetermined temperature may be read from a storage location in the memory 204. The state of the press 20 is indicated by illuminating the heating state indicator tight 44 on the press 20. The display 40 may be driven by the control circuit 200 to indicate the heating state. The display 40 may alternatively provide a time display indicating the remaining duration of the heating cycle. The duration of the heating cycle may be a predetermined time period stored in the memory 204 of the control circuit 200.

When the time period of the heating cycle expires, the control circuit 200 transitions to the cooling state 308 via path 328. In the cooling state 308, the control circuit 200 continues to engage the tray latch 100 preventing the tray 22 with the heated beads from being retracted. The heating element 130 is de-energized and a cooling fan 80 may be turned on to accelerate the cooling of the heated beads. The tray actuators 90 are de- energized, allowing the tray springs 92 to lower the tray 22 away from the heating plate 120. The cooling state 308 may be indicated by using a yellow illuminated indicator 46. The display 40 may be driven by the control circuit 200 to indicate the cooling state 308. The display 40 may alternatively provide a time display indicating the remaining duration of the cooling cycle. The duration of the heating cycle may be a predetermined time period stored in the memory 204 of the control circuit 200. Alternatively, the remaining duration of the cooling cycle may be calculated based on a temperature read from a sensor disposed within the press 20. In one embodiment, the temperature sensor 132 used to monitor the heating plate temperature may be used to estimate the remaining time required for the cooling cycle. In another embodiment, a temperature sensor in the air stream may be used to estimate the remaining time required for the cooling cycle. In yet another embodiment, the display 40 may indicate an estimated temperature of the beads calculated from the expired duration of the cooling cycle and/or temperature information measured with the press 20.

Once the time period for the cooling cycle has expired, the control logic transitions to the cooled state 310 via path 330. In the cooled state 310, the tray latch 100 is released allowing the tray support plate 94 to be withdrawn from the press 20, providing access to the fused and cooled beads. In the cooled state 310, a green all safe indicator 48 is illuminated to indicate that the beads are cooled to a safe temperature. The cooling fan 80 is turned off. Once the user withdraws the tray support plate 94 to access the tray 22 and the beads, the control logic transitions to back to the start state 302 via path 332.

In the described embodiment the control logic is implemented using software stored in a computer readable medium with the device. The control logic (software) is executed by the processor 202 causing the processor 202 to perform the functions of the invention as described herein.

In another embodiment, the elements are implemented primarily in hardware using, for example, hardware components such as application specific integrated circuits (ASICs). Implementation of the hardware state machine in order to perform the functions described herein wilt be apparent to persons skilled in the relevant art(s).

In yet another embodiment, elements are implemented using a combination of both hardware and software.

Additional safety checks may be performed during the states described with the logic control transitioning or remaining in the start state 302 when a safety check fails. For example, an abnormally high current may indicate that a solenoid actuator is restricted from making a full stroke, indicating that the tray path to the heating plate 120 may be blocked. A low or zero current value may indicate that the solenoid coil has failed. The current provided to the heating element 130 may also be monitored, with abnormally high or low currents being indicative of a failed or shorted heating element. The failed conditions may result in a diagnostic message being sent to the display 40. A level sensor may be included to indicate the orientation of the bead fuser. The control logic may maintain the device in the start state 302 when the level sensor indicates that the bead fuser is not properly oriented. One skilled in the art would appreciate that sensors monitoring additional conditions may be interfaced to the control circuit to detect additional potentially unsafe conditions for operating the press 20.

Preferably, the state indicator lights are of the red, green and yellow in color and are arranged in an orientation similar to a traffic signal light. The use of a familiar color scheme and orientation may allow younger users to successfully operate the press 20. Alternative arrangements of the display may be used. For example, in one embodiment, color and arrangement of the indicators is chosen to provide an aesthetic appearance. The indicator light system may be omitted, with all of the relevant state information being provided via the alphanumeric display. The alphanumeric display provides additional information, which may allow older children and adults to diagnose problems with the press 20 and or to provide them with additional information concerning the operation of the press 20.

The tray actuators are described as solenoid actuators in the described embodiment. In another embodiment, any electrically operated or actuated mechanism, which will produce a linear movement of the tray towards the heating plate, may be used. For example, the tray actuator may be a motor driven apparatus using a gearing arrangement to produce a vertical motion of the tray 22. The operation of the motor may wind a spring, which reverses the direction of the tray when the motor is de-energized. Alternatively, the motor may be operated in the reverse direction to move the tray 22 away from the heating plate 120.

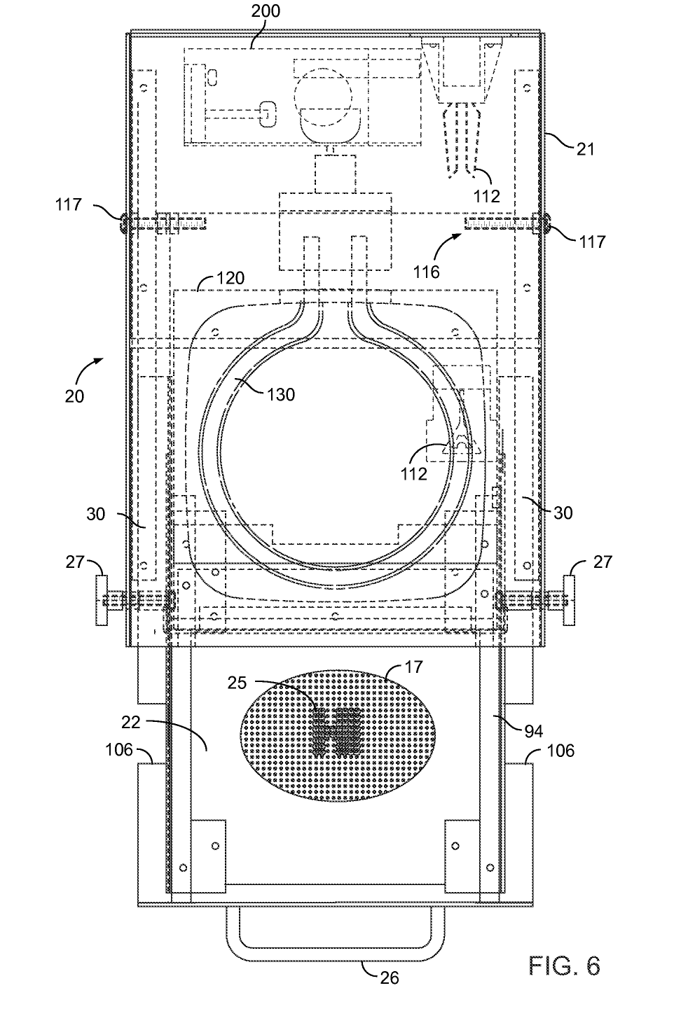

In a preferred embodiment of the invention, illustrated in FIGS. 6-8, a spring 92 is disposed within the enclosure 21 that biases the heating element 130 into an elevated position over the tray 22 (FIGS. 7A and 7B). At least one knob 27 mechanically connected to the heating element 130 at a forward end is captured in at least one inverted J-shaped slot 29 of the enclosure 21. An upper end of each J-shaped slot 29 holds the knobs 27 in an elevated position, thereby holding the heating element 130 in the elevated position. The heating assembly 115 is pivoted at a pivot means 116, such as a bolt 117, at a rear end thereof (FIG. 7A). A lower end of each J-shaped slot 29 allows each knob 27 to fall into a lowered position, thereby allowing the heating element 130 to assume a lowered position such that the heating element 130 achieves close mutual proximity with the tray 22, and contacts any beads 25 that are resting on the tray 22 in order to fuse the beads 25 together (FIG. 7C).

In such an embodiment, wherein the heating element 130 is movable between an elevated and a lowered position, once the beads 25 are fused they may stick to the heating element 130 when same is raised to the elevated position. As such, a generally horizontal second slot 33 is further included in the face 18 of the enclosure 21 (FIGS. 7D and 8), and a scraper 35 may be introduced therein to pry the fused beads 25 away from the heating element 130.

The control circuit 200 in such an embodiment may be altered slightly from that previously detailed. In such an embodiment, the control circuit 200 may, upon depression of a power switch 42, energize the heating element 130 if the proximity detector sensor 112 indicates that the tray 22 is directly under the heating element 130 and that the tray support means 94 is fully inserted into the slot 32. Upon actuation of the heating element 130, the temperature sensor 132 indicates when the heating element 130 has reached a predefined operating temperature sufficient to fuse the beads 25. At this point, a “ready to melt” indicator light 44 is actuated, signaling to the user that he may use the knobs 27 to lower the heating element 130 onto the beads 25. A timing means of the control circuit 200 is then initiated, and upon the expiration thereof the heating element 130 is de-energized. At such a time, a “done melting” indicator light 48 is actuated, signaling to the user that the knobs 27 may be lifted and set into the raised position to raise the heating element 130. A second cooling timing means is at this point initiated, and upon the expiration of same a “finished” indicator light 48 is actuated, alerting the user that sufficient cooling time has elapsed and that the user may remove the beads 25 from the enclosure 21. If the beads 25 have stuck to the heating element, the scraper 35 may be inserted into the second slot 33 to dislodge the beads 25 from the heating element 130. Preferably, a portion 23 of the enclosure 21 is transparent (FIG. 8) so that the user may see inside the enclosure 21 to determine if the beads 25 have stuck to the heating element 130, and in order to direct the scraper 35 accurately between the beads 25 and the heating element 130.

To prevent the tray 22 from being removed while the heating element 130 is in the lowered position, the heating assembly 115 may further include a locking post 105 (FIGS. 7A and 7C) and the tray support 94 may include a locking post receiving means 106 (FIG. 6). The locking post 105 engages the locking post receiving means 106 when the heating element 130 is not in the raised position (FIG. 7C), thereby preventing the tray support means 94 from sliding out of the enclosure interior 19.

It is to be understood that the present invention is not limited to the embodiments described above. For example, the exactly type, placement, and state indications of the various indicator lights 44, 46, 48 may be varied in any number of ways. Further, a different number of such indicator lights may be used, for example, with or without the alphanumeric display 40. Further, the mechanism used to bring the heating plate 130 into contact with the beads 25 may be varied in a wide variety of ways. As such, the present invention encompasses any and all embodiments within the scope of the following claims.

What is claimed is:

1. A press for fusing beads, comprising:
an enclosure having a hollow interior, a face of the enclosure having a slot defined therein;
a heating assembly disposed within the enclosure, the heating assembly having a heating plate, and a heating element in thermal contact with the heating plate;
a tray support plate adapted for holding a tray, the tray support plate slidably engaging the open slot of the enclosure, whereby the tray support may be slid into the enclosure interior to a position beneath the heating plate;
a vertical actuator mechanism disposed within the enclosure operable to bring the tray and the heating element into close mutual proximity;
a position sensor operable to detect when the tray support is positioned fully under the heating plate; and
a control circuit in electrical connection with the heating element and the position sensor, the control circuit for energizing the heating element to maintain the heating plate at a predetermined temperature when the tray support plate is positioned under the heating plate.

2. The press of claim 1 further including a spring disposed within the enclosure, the spring being biased to hold the tray in contact with the tray support, and wherein the vertical linear actuator mechanism is operable to lift the tray against the spring and into contact with the heating element.

3. The press of claim 1 further including a spring disposed within the enclosure, the spring being biased to hold the heating element in an elevated position, and wherein the vertical actuator mechanism is operable to lower the heating element against the spring and into contact with the tray.

4. The press of claim 3 wherein the vertical actuator is a pair of manually operated knobs mechanically connected to the heating element, and wherein the enclosure includes a pair of inverted J-shaped slots for receiving the knobs, an upper end of the J-shaped slots for holding the heating element in the elevated position and a lower end of the J-shaped slots for allowing the heating element to achieve a lowered position in contact with the tray.

5. The press of claim 3 wherein the enclosure further includes a second generally horizontal slot and further including a scraper, such that if the beads become stuck to the heating element, with the heating element in the elevated position the scraper may be introduced into the second slot to dislodge the beads from the heating element.

6. The press of claim 1 further including a temperature sensor in thermal contact with the heating plate and in electrical communication with the control circuit, whereby the control circuit prevents heating of the heating element above the predefined temperature.

7. The press of claim 1 further including a power switch in electric communication with the control circuit, whereby the control circuit applies power to the heating element only when both the power switch is actuated and the position sensor detects that the tray support plate is positioned under the heating plate.

8. The press of claim 1 wherein the control circuit includes a timing means, whereby power is applied to the heating element only for a predetermined period of time.

9. The press of claim 3 wherein the heating assembly further include a locking post and the tray support includes a locking post receiving means, whereby when the tray support is not fully engaged with the enclosure interior the heating element is prevented from moving out of its elevated position.

10. The press of claim 3 wherein the heating assembly further include the locking post and the tray support includes the locking post receiving means, whereby when the heating element is not in the elevated position, the locking post engages the locking post receiving means to prevent the tray support from sliding out of the enclosure interior.

11. The press of claim 1 wherein at least a portion of the enclosure is transparent.

12. The press of claim 6 wherein the control circuit further includes a “ready to melt” indicator light for indicating that the heating element has reached the predetermined temperature.

13. The press of claim 1 wherein the control circuit further includes a “now heating” indicator light for indicating that power is being applied to the heating element.

14. The press of claim 7 wherein the control circuit further includes a “done melting” indicator light for indicating that the predetermined time has expired and that the heating element can be raised to its elevated position.

15. The press of claim 1 wherein the control circuit includes a second cooling timing means and a “finished” indicator light, whereby the second timing means is actuated upon the heating element being de-energized, the “finished” indicator light being illuminated only after a predetermined cooling period of time has past.
